(19) United States
(12) Patent Application Publication
(10) Pub. No.: US 2025/0168577 A1
(43) Pub. Date: May 22, 2025

(54) HEARING DEVICE WITH RECEIVER PROTECTION FOAM

(71) Applicant: GN Hearing A/S, Ballerup (DK)

(72) Inventor: Yu LUAN, Kongens Lyngby (DK)

(73) Assignee: GN Hearing A/S, Ballerup (DK)

(21) Appl. No.: 18/932,608

(22) Filed: Oct. 30, 2024

(30) Foreign Application Priority Data
Nov. 16, 2023 (EP) 23210254.1

(51) Int. Cl. H04R 25/00

(52) U.S. Cl. CPC H04R 25/604; H04R 25/609; H04R 25/65

(57) ABSTRACT

A hearing device is disclosed. The hearing device comprises a housing comprising a receiver cavity. The hearing device comprises a back vented receiver. The hearing device comprises a receiver suspension. The receiver suspension is made of a foam material.

### RELATED APPLICATION DATA

This application claims priority to, and the benefit of, European Patent Application No. 23210254.1 filed on Nov. 16, 2023. The entire disclosure of the above application is expressly incorporated by reference herein.

### FIELD

The present disclosure relates to a hearing device and in particular to a hearing device comprising a receiver suspension made of a foam material.

### BACKGROUND

Back-ventilation of receivers enables improved provision of low frequency audio signals by a receiver, thereby improving the acoustic power output provided to a user of a hearing device. To enable this improved provision of low frequency signals, additional ventilation space is required in the internal structure of the hearing devices. However, due to size limitations imposed by the confined spaces in which hearing devices are typically applied, it may be a challenge to provide any ventilation space in the hearing device for the purpose of back-venting a receiver.

### SUMMARY

Accordingly, there is a need for hearing devices with improved flexibility in design, e.g. further size reduction of the hearing device, while maintaining and/or improving the quality of the audio output provided by the back-vented receiver of the hearing device.

A hearing device is disclosed. The hearing device comprises a housing comprising a receiver cavity. The hearing device comprises a receiver, such as a back vented receiver. A back vented receiver comprises at least one back vent. The hearing device comprises a receiver suspension, wherein the receiver suspension optionally is made of or at least comprises a foam material.

It is an important advantage of the hearing device that, by using a foam material for the receiver suspension, the size of the receiver cavity made be reduced while maintaining, such as improving, the quality, range, and/or acoustic power of the output of the back vented receiver.

The present disclosure allows for improved flexibility in design, e.g. further reduced sizing of the hearing device. In other words, the disclosed hearing device enables a reduction in the size, such as dimensions, of the hearing device. Advantageously, the present disclosure allows for improved flexibility in design, e.g. further reduced sizing of the hearing device, such as a reduced size, while at least maintaining the quality, such as the low-frequency output, of the audio signal transmitted by the back-vented receiver. Further, a more robust hearing device is provided, e.g. a hearing that is less sensitive to being dropped.

The present disclosure may for example allow for improved flexibility in the design and/or structure of the hearing device, such as in the internal infrastructure of the hearing device.

Further, the present disclosure may enable to at least maintain, such as improve, the vibration isolation of the back-vented receiver of the hearing device while enabling improved flexibility in design, e.g. further reduced sizing of the hearing device.

Furthermore, the present disclosure may allow for improved shock protection and/or vibration isolation of the back-vented receiver, e.g., by using the foam material for the receiver suspension. For example, the disclosed hearing device may enable shock protection and/or vibration isolation of the hearing device while allowing for the size of the hearing aid to be reduced.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 shows an example hearing device according to the disclosure,

FIG. 2 schematically illustrates an exemplary back vented receiver and receiver suspension according to the disclosure, and

FIG. 3 is a graph of example back vented receiver outputs.

### DETAILED DESCRIPTION

Various exemplary embodiments and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device is disclosed. The hearing device may be configured to be worn at an ear of a user and may be a hearable or a hearing aid, wherein the processor is configured to compensate for a hearing loss of a user.

In some examples, the hearing device may be an earbud, a headphone, or a hearing aid, etc.

The hearing device may be a hearing aid of the behind-the-ear (BTE) type, in-the-ear (ITE) type, in-the-canal (ITC) type, receiver-in-canal (RIC) type, receiver-in-the-ear (RITE) type or microphone-and-receiver-in-the-ear (MaRIE) type. The hearing device may be a binaural hearing aid in a binaural hearing system. The binaural hearing system may comprise a first hearing aid and a second hearing aid, wherein the first hearing aid and/or the second hearing aid may be the hearing device(s) as disclosed herein.

The hearing device may be configured for wireless communication with one or more devices, such as with another hearing device, e.g. as part of a binaural hearing system, and/or with one or more accessory devices, such as a smartphone and/or a smart watch. The hearing device optionally comprises an antenna for converting one or more wireless input signals, e.g. a first wireless input signal and/or a second wireless input signal, to antenna output signal(s). The wireless input signal(s) may origin from external source(s), such as spouse microphone device(s), wireless TV audio transmitter, and/or a distributed microphone array associated with a wireless transmitter. The wireless input signal(s) may origin from another hearing device, e.g. as part of a binaural hearing system, and/or from one or more accessory devices.

The hearing device optionally comprises a radio transceiver coupled to the antenna for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device may comprise a plurality of antennas and/or an antenna may be configured to be operate in one or a plurality of antenna modes. The transceiver input signal optionally comprises a first transceiver input signal representative of the first wireless signal from a first external source.

The hearing device comprises a set of microphones. The set of microphones may comprise one or more microphones. The set of microphones comprises a first microphone for provision of a first microphone input signal and/or a second microphone for provision of a second microphone input signal. The set of microphones may comprise N microphones for provision of N microphone signals, wherein N is an integer in the range from 1 to 10. In one or more exemplary hearing devices, the number N of microphones is two, three, four, five or more. The set of microphones may comprise a third microphone for provision of a third microphone input signal.

The hearing device optionally comprises a processor for processing input signals, such as transceiver input signal and/or microphone input signal(s). The processor provides an electrical output signal based on the input signals to the processor, the electrical output signal being fed to the receiver for provision of acoustic sound signals.

It is noted that descriptions and features of hearing device functionality, such as hearing device configured to, also apply to methods and vice versa. For example, a description of a hearing device configured to determine also applies to a method, e.g. of operating a hearing device, wherein the method comprises determining and vice versa.

The hearing device comprises a housing comprising a receiver cavity. The hearing device comprises a receiver, such as a back vented receiver, optionally arranged in the receiver cavity. The hearing device comprises a receiver suspension. The receiver suspension is made of a foam material or at least comprises a foam material and is optionally arranged around the receiver within the receiver cavity.

The housing of the hearing device may comprise a frame and a shell.

The receiver cavity can for example be a space, such as a volume, surrounding or accommodating at least a part of the back vented receiver. The receiver cavity can for example be seen as a receiver chamber. In some examples, the receiver cavity is, at least partly, encapsulated by the housing of the hearing device.

In one or more example hearing devices, the hearing device, such as the housing, comprises a sealing can. The sealing can may for example be seen as the external casing of the receiver cavity. In other words, the sealing can may be seen an external housing of the receiver cavity.

The receiver cavity may be, at least partly, encapsulated by a sealing can. The sealing can may for example be configured to seal the receiver chamber. In some examples, the receiver cavity can be seen as a back-vented receiver cavity.

The back vented receiver may be seen as a receiver comprising a back vent. The back vent of the back vented receiver is for example configured for venting of fluid, such as air, from the back chamber or back cavity of the receiver. In some examples, a ventilation of the back vented receiver, e.g., via the receiver cavity, may allow for improved performance of the back vented receiver. For example, ventilation of the back vented receiver may enable providing low frequency outputs with an improved accuracy and/or a greater acoustic power output. For example, the ventilation may enable improved compliance of the receiver membrane.

The receiver suspension may be configured to suspend or support the back vented receiver, such as at least partly within the receiver cavity. The receiver suspension may for example be configured to support the back vented receiver within the hearing device, e.g. in the frame and/or the housing. In other words, the receiver suspension is for example configured to keep the back vented receiver in place, such as fixed in a given position. In some examples, the receiver suspension is configured to provide shock protection and/or vibration isolation for the back vented receiver. The receiver suspension may for example enable shock protection by allowing the back vented receiver to compress, such as elastically deform, the receiver suspension, e.g., when a force, such as a shock, is applied to the hearing device.

In one or more example hearing devices, the receiver suspension comprising a foam material covers at least a part of a back vent of the back vented receiver.

At least one back vent is located on a side of the receiver which is different from the side where the sound outlet of the receiver is located. For example, the back of the back vented receiver can be seen as an opposite and/or adjacent side of the back vented receiver from the side which the sound outlet, such as an acoustic sound signal, is provided. The side of the back vented receiver from which the acoustic sound output is provided may be seen as a front of the back vented receiver. The back vent can for example be seen as an air vent, an air outflow and/or an air exhaust.

In one or more example hearing devices, the foam material is an open cell foam. Open cell foam can for example be seen as porous foam. In some examples, the open cell foam can be seen as permeable foam. The open cell foam can for example be seen as being characterised by a plurality of interconnected voids and/or cells. One or more of the interconnected voids and/or cells of the open cell foam are for example open, such as not enclosed. The open nature of the cells of the foam material may enable the foam material to be porous, and thereby may allow for fluid, such as air, to pass through the open cell foam.

This may advantageously enable the ventilation of the back vented receiver to occur via the receiver suspension, such as through the foam material of the receiver suspension.

In one or more example hearing devices, the open cell foam is a polyurethane based foam.

For example, the foam material may comprise a composition based on polyurethane. For example, the foam material may have a percentage composition of greater than 50% polyurethane (v/v or w/w). For example, the foam material may have a percentage composition of greater than 80% polyurethane. For example, the foam material may have a percentage composition of greater than 90% polyurethane. For example, the foam material may have a percentage composition of greater than 99% polyurethane. The foam material may for example be a Roger polyurethane foam, such as Roger 79-09021P, 15TS1-06030, and/or 15-06030P foam.

The volume between the back vented receiver and the sealing can, without taking into account the receiver suspension, may be represented as receiver cavity volume, V_{C}.

The receiver suspension for example occupies a portion of the receiver cavity volume, V_{C}. The volume of the receiver suspension can be represented as receiver suspension volume, V_{S}.

For optimal operation of the back vented receiver, a given volume for ventilation of the back vented receiver via a back vent may be required. The back vented volume required for optimal operation of the back vented receiver may be represented as V_{BV}.

Due to the porous nature of the receiver suspension made of the foam material, air, such as back vented air of the back vented receiver, may pass through the receiver suspension. Therefore, the receiver suspension may be considered as an air volume of the receiver cavity. In other words, the receiver suspension, e.g., made of the foam material, can be seen as a part of the receiver cavity.

The following equation may therefore be applied to the hearing device,

$${V}_{C} = {V}_{BV} \qquad ( 1 )$$

In other words, due to the porous nature of the receiver suspension enabling air, such as back vented air of the back vented receiver, to pass through the receiver suspension, the receiver cavity need not comprise both a receiver suspension and also a back vented volume. In other words, the receiver suspension may be configured such that is may be seen as at least a part of the back vented volume, V_{BV}.

For example, when a back vented receiver comprising a receiver suspension volume of 40 mm3 uses a receiver suspension made of a non-porous material, such as rubber, the cavity volume required for optimal operation of the back vented receiver may be represented as shown in Equation 2:

$${V}_{C} = {V}_{BV} + volume of non - porous receiver suspension \qquad ( 2 )$$

When the receiver suspension comprises the foam material, volume of non-porous receiver suspension can be removed as the volume of the receiver suspension made of the foam material can be seen as a part of the V_{BV}, e.g., due to the porous nature of the foam material. This may thereby enable the V_{C} to be reduced by the volume of non-porous receiver suspension, e.g., 40 mm3. In other words, the V_{C} may be reduced when the receiver suspension is made of a foam material instead of being made of a non-porous material, such as rubber.

In one or more example hearing devices, the foam material has a Young's Modulus in the range from 0.01 MPa to 1 MPa.

The foam material may for example be capable of or configured for elastic deformation. In other words, when a force is applied to the foam material and then subsequently removed, the foam material may return to its original shape, such as the shape of the foam material prior to when the force was initially applied.

In one or more example hearing devices, the foam material has a density in the range from 100 kg/m3 to 561 kg/m3.

In one or more example hearing devices, the receiver suspension is formed as a foam sheet.

The foam sheet can for example be seen as a sheet comprising the foam material. In some examples, the foam sheet comprising the foam material is wrapped around at least a part of the back vented receiver. In one or more example hearing devices, the foam sheet has a thickness in the range from 0.3 mm to 2 mm.

In one or more example hearing devices, the housing comprises a frame. In one or more example hearing devices, the back vented receiver is attached to the frame via the receiver suspension.

The frame can be for example seen as being configured for attachment and/or fixing of components of the hearing device. The hearing device comprises a back vented receiver arranged within the housing, such as attached to the frame. In some examples, the back vented receiver may be hard mounted, e.g. via the receiver suspension, to the frame. In some examples, the back vented receiver may be soft mounted to the frame. In some examples, the back vented receiver can be seen as being fixed to the frame of the hearing device.

In some examples, components of the hearing device, such as one or more of: back vented receiver, microphone(s), battery, processor, Printed Circuit Board, etc., may be mounted on the frame.

In one or more example hearing devices, a shell or shell parts is/are attached to the frame. In one or more example hearing devices, the frame carries a Printed Circuit Board (PCB).

The shell/shell parts of the hearing device can for example be seen as an external casing of the hearing device.

The printed circuit board (PCB) can for example be seen as a board comprising one or more conductive pathways. The PCB for example serves as a platform for mounting and/or connecting electronic components, such as a microchip and/or wiring.

In one or more example hearing devices, the foam material has a compression deflection 25% in the range from 5 kPa to 10 kPa. Compression deflection can be seen as a measure indicative of the force per unit area to compress the foam material by 25% of its original thickness.

In one or more example hearing devices, the receiver suspension may cover in the range from 10% to 100% of an outer surface of the back vented receiver, such as more than 50% of an outer surface of the back vented receiver. The outer surface of the back vented receiver can for example be seen as the external surface of the back vented receiver. For example, the outer surface of the back vented receiver may be seen as external shell of the back vented receiver. In other words, the receiver suspension for example encapsulates between 10% and 100% of the back vented receiver.

In one or more example hearing devices, the receiver suspension comprises one or more openings. The one or more openings can for example be seen as one or more gaps in the receiver suspension. The one or more openings in the receiver suspension may enable improved mechanical de-coupling, such as by increasing vibration isolation/vibration attenuation, of the back vented receiver.

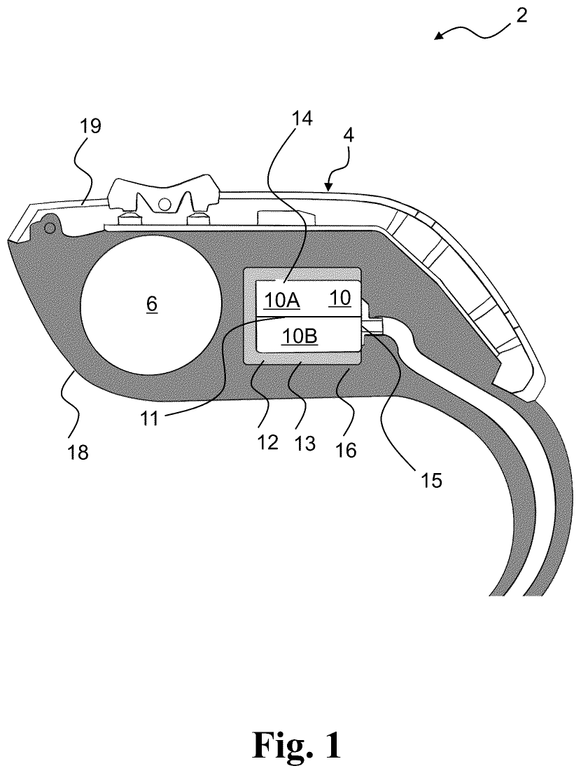

FIG. 1 shows an example hearing device according to the disclosure, the hearing device 2 comprising a housing 4 comprising a receiver cavity 13. The hearing device 2 comprises a back vented receiver 10. The hearing device 2 comprises a receiver suspension 12. The receiver suspension 12 is made of a foam material.

The back vented receiver 10 comprises a membrane 11 and a back vent 14 for ventilation of back chamber 10A of the back vented receiver 10. In other words, air may be ventilated from the back vented receiver 10 via the back vent 14. The receiver cavity 13 is separated by the membrane into back chamber 10A and front chamber 10B and is at the back vent 14 optionally at least partially occupied by the receiver suspension 12 made of the foam material, such as open cell foam. The volume of the receiver cavity 13 is at least partially occupied by the receiver suspension 12. The foam material, of which the receiver suspension 12 is made, is for example porous, e.g., the foam material may be an open cell foam such as polyurethane based foam. The foam material, of which the receiver suspension 12 is made, can for example be seen as a foam sheet. The front chamber 10A is provided with a sound output 15.

The housing 4 hearing device 2 comprises a frame 18 and a shell 19. The shell 19 is attached, such as fixed, to the frame 18. The back vented receiver 10 may be attached to the frame 18 via the receiver suspension 12.

The hearing device 2 optionally comprises a sealing can 16. The sealing can 16 at least partially encapsulates one or more of: the back vented receiver, the receiver cavity and the receiver suspension. The hearing device 2 further comprises a battery 6.

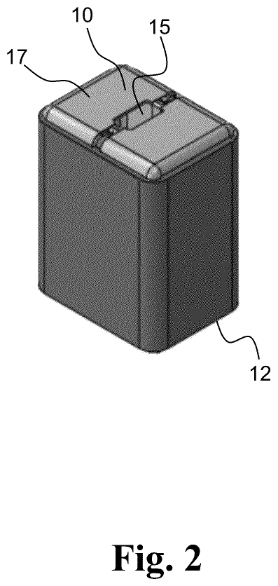

FIG. 2 schematically illustrates an example back vented receiver and receiver suspension according to the disclosure. FIG. 2 shows a back vented receiver 10 and a receiver suspension 12. The receiver suspension 12 is made of a foam material, such as an open cell polyurethane based foam. The back vent of the back vented receiver can for example be seen as being located under the receiver suspension 12, i.e. the receiver suspension may cover the back vent. FIG. 2 shows the front 17 of the back vented receiver 10. The front 17 of the back vented receiver 10 comprises sound output 15 from where the audio output is provided.

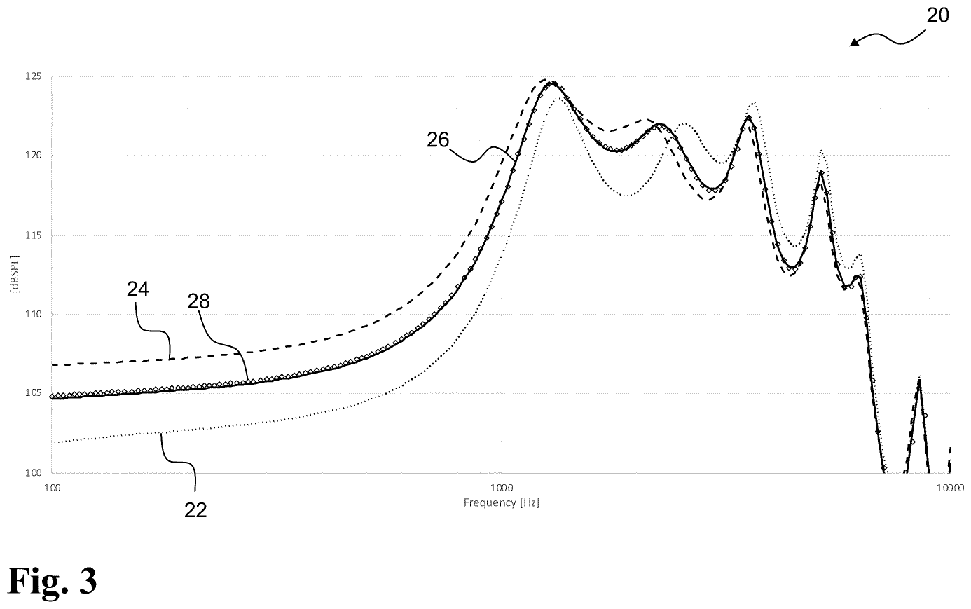

FIG. 3 is a graph of exemplary back vented receiver outputs. FIG. 3 shows a representation 20 indicating the output a back vented receiver, such as back vented receiver 10 shown in FIGS. 1-2, with various receiver suspensions and/or receiver cavities. The x-axis of the representation 20 indicates the frequency of the output of the back vented receiver. The y-axis of the representation 20 indicates a decibel of sound pressure level (dB SPL) of the back vented receiver. The back vented receiver used was a E50D receiver. The E50D receiver was measured with BTE load with 200 mV input from a 22 ohms generator.

Graph 22 is a dotted line indicating the output of the back vented receiver where the receiver cavity has a negligible, such as zero or near zero, volume. For example, graph 22 indicates the output of the back vented receiver when the back vent is sealed, e.g., when there is no back vented volume. In other words, graph 22 indicates the back vented receiver output when no ventilation can occur via the back vent of the back vented receiver.

Graph 24 is a dashed line indicating the output of the back vented receiver where there is no receiver cavity. For example, graph 24 indicates the output of the back vented receiver when the back vent is open, e.g., where the back vented volume is not limited. For example, the graph 24 indicates the output of the back vented receiver when the volume of the receiver cavity is not limited by a receiver cavity housing, such as shell. In other words, graph 24 indicates the back vented receiver output the receiver cavity does not impose a limit on the ventilation which can occur via the back vent of the back vented receiver. For example, the back vent can be seen as fully open, not limited, and/or not sealed for graph 24.

Graph 26 is a solid line indicating the output of the back vented receiver when the volume of the receiver cavity is 50 mm3. For graph 26, the receiver cavity was empty, such as only containing air.

Graph 28, as represented by square boxes, indicates the output of the back vented receiver when the volume of the receiver cavity is 50 mm3. For graph 28, the receiver cavity was filled with a foam material comprising an open cell foam. The foam used was a Polyurethane foam, Roger 79-09021P.

Representation 20 shows that the open cell foam in the receiver cavity does not change coupler pressure. In other words, despite the receiver cavity comprising the open cell foam as in graph 28, the performance of the back vented receiver was not affected when compared with to the empty receiver cavity of graph 26. This indicates that air may pass freely in and out the open cell foam, and the foam does not reduce the back vented volume.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that the figures comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

2 hearing device
4 housing
6 battery
10 back vented receiver
10A back chamber
10B front chamber
11 membrane
12 receiver suspension
13 receiver cavity
14 back vent
15 sound output
16 sealing can
17 front
18 frame
19 shell
20 representation
22 graph
24 graph
26 graph
28 graph

1. A hearing device comprising:
a housing comprising a receiver cavity;
a back vented receiver; and
a receiver suspension;
wherein the receiver suspension is made of a foam material.

2. The hearing device according to claim 1, wherein the foam material is an open cell foam.

3. The hearing device according to claim 1, wherein the foam material is polyurethane-based.

4. The hearing device according to claim 1, wherein the foam material has a Young's Modulus in a range from 0.01 MPa to 1 MPa.

5. The hearing device according to claim 1, wherein the foam material has a density in a range from 100 kg/m³ to 561 kg/m³.

6. The hearing device according to claim 1, wherein the receiver suspension is in a form of a foam sheet.

7. The hearing device according to claim 6, wherein the foam sheet has a thickness in a range from 0.3 mm to 2 mm.

8. The hearing device according to claim 1, wherein the housing comprises a frame, and wherein the back vented receiver is attached to the frame via the receiver suspension.

9. The hearing device according to claim 8, further comprising a shell attached to the frame.

10. The hearing device according to claim 8, further comprising a Printed Circuit Board coupled to the frame.

11. The hearing device according to claim 1, wherein the foam material has a compression of 25% of an original thickness of the foam material when the form material is compressed by a pressure in a range from 5 kPa to 10 kPa.

12. The hearing device according to claim 1, wherein the receiver suspension covers at least a part of a back vent of the back vented receiver.

13. The hearing device according to claim 1, wherein the receiver suspension covers 10% to 100% of a surface of the back vented receiver.

14. The hearing device according to claim 13, wherein the surface of the back vented receiver is an outer surface of the back vented receiver.

15. The hearing device according to claim 1, wherein the receiver suspension comprises one or more openings.

16. The hearing device according to claim 1, wherein the hearing device comprises a sealing can.
